(19) United States
(12) Patent Application Publication
(10) Pub. No.: US 2025/0192324 A1
(43) Pub. Date: Jun. 12, 2025

(54) CELL STACK INTERLOCKING ASSEMBLIES FOR TRACTION BATTERY PACKS

(71) Applicant: FORD GLOBAL TECHNOLOGIES, LLC, Dearborn, MI (US)

(72) Inventor: Joseph Fricano, Canton, MI (US)

(21) Appl. No.: 18/966,840

(22) Filed: Dec. 3, 2024

Related U.S. Application Data
(60) Provisional application No. 63/607,888, filed on Dec. 8, 2023.

(51) Int. Cl. H01M 50/264; H01M 10/658; H01M 50/204; H01M 50/249

(52) U.S. Cl. CPC H01M 50/264; H01M 10/658; H01M 50/204; H01M 50/249; H01M 2220/20

(57) ABSTRACT

Interlocking assemblies are provided for use within cell stacks of a traction battery pack. An exemplary interlocking assembly may include a crossmember frame, a structural thermal barrier, an adhesive, and a rod. The adhesive may be disposed between the crossmember frame and the structural thermal barrier. The rod may then be inserted through the crossmember frame and the structural thermal barrier for retaining the structural thermal barrier to the crossmember frame while the adhesive cures.

### CROSS-REFERENCE TO RELATED APPLICATIONS

This disclosure claims the benefit of U.S. Provisional Application No. 63/607,888, which was filed on Dec. 8, 2023 and is incorporated herein by reference in its entirety.

### TECHNICAL FIELD

This disclosure relates generally to traction battery packs, and more particularly to cell stack interlocking assemblies that can reduce cell stack assembly times during manufacturing.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first crossmember frame including a first channel, a structural thermal barrier positioned within the first channel, a first adhesive disposed between the first crossmember frame and the structural thermal barrier, and a first rod inserted through the first crossmember frame and the structural thermal barrier.

In a further non-limiting embodiment of the foregoing traction battery pack, the first rod is configured to retain the structural thermal barrier to the first crossmember frame while the first adhesive cures.

In a further non-limiting embodiment of either of the foregoing traction battery packs, the first crossmember frame is a subcomponent of a cross-member assembly of a cell stack of the traction battery pack, and the structural thermal barrier is a subcomponent of a thermal barrier assembly of the cell stack.

In a further non-limiting embodiment of any of the foregoing traction battery packs, a second crossmember frame includes a second channel, and the structural thermal barrier is positioned within the second channel. A second adhesive is disposed between the second crossmember frame and the structural thermal barrier, and a second rod is inserted through the second crossmember frame and the structural thermal barrier.

In a further non-limiting embodiment of any of the foregoing traction battery packs, the first crossmember frame includes an upper section, a lower section, and a mid-section that connects between the upper section and the lower section.

In a further non-limiting embodiment of any of the foregoing traction battery packs, the first channel extends vertically across an inner facing surface of the first crossmember frame.

In a further non-limiting embodiment of any of the foregoing traction battery packs, a first channel portion of the first channel is formed in the upper section, a second channel portion of the first channel is formed in the lower section, and a third channel portion of the first channel is formed in the mid-section.

In a further non-limiting embodiment of any of the foregoing traction battery packs, the first channel portion and the second channel portion each extend to a first depth of a material thickness of the first crossmember frame, and the third channel portion extends to a second depth of the material thickness. The first depth is greater than the second depth.

In a further non-limiting embodiment of any of the foregoing traction battery packs, the first rod is accommodated within a through bore of the first crossmember frame.

In a further non-limiting embodiment of any of the foregoing traction battery packs, the first rod is received through an opening of a mounting tab of the structural thermal barrier.

In a further non-limiting embodiment of any of the foregoing traction battery packs, the first rod includes a threaded opening sized to receive a threaded fastener.

In a further non-limiting embodiment of any of the foregoing traction battery packs, the threaded fastener is received through an opening of a structural plate member that is arranged between a cell stack of the traction battery pack and a side wall of an enclosure assembly of the traction battery pack.

A traction battery pack according to another exemplary aspect of the present disclosure includes, among other things, a cell stack including an interlocking assembly that includes a first crossmember frame, a structural thermal barrier, and a first rod that secures the structural thermal barrier to the first crossmember frame. A structural plate member is positioned to span an end of the cell stack, and a first threaded fastener is received through a first opening of the structural plate member and configured to engage a first threaded opening of the first rod for securing the structural plate member to the cell stack.

In a further non-limiting embodiment of the foregoing traction battery pack, the interlocking assembly includes a second crossmember frame and a second rod that secures the structural thermal barrier to the second crossmember frame.

In a further non-limiting embodiment of either of the foregoing traction battery packs, a second threaded fastener is received through a second opening of the structural plate member and is configured to engage a second threaded opening of the second rod for further securing the structural plate member to the cell stack.

In a further non-limiting embodiment of any of the foregoing traction battery packs, the structural thermal barrier is positioned within a first channel of the first crossmember frame.

In a further non-limiting embodiment of any of the foregoing traction battery packs, an adhesive is disposed between the structural thermal barrier and the first crossmember frame.

In a further non-limiting embodiment of any of the foregoing traction battery packs, the first channel extends vertically across an inner facing surface of the first crossmember frame.

In a further non-limiting embodiment of any of the foregoing traction battery packs, the first rod is accommodated within a through bore of the first crossmember frame.

In a further non-limiting embodiment of any of the foregoing traction battery packs, the first crossmember frame is a subcomponent of a cross-member assembly of the cell stack, and the structural thermal barrier is a subcomponent of a thermal barrier assembly of the cell stack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an interlocking assembly of a cell stack of the traction battery pack of FIG. 2.

FIG. 4 is an exploded view of the interlocking assembly of FIG. 3.

FIG. 5 is a cross-sectional view through section 5-5 of FIG. 3.

FIGS. 6 and 7 illustrates an exemplary crossmember frame of an interlocking assembly of a traction battery cell stack.

FIG. 8 illustrates an exemplary structural thermal barrier of an interlocking assembly of a traction battery cell stack.

FIG. 9 illustrates an exemplary interface between an interlocking assembly of a cell stack and a structural plate member of a traction battery pack.

### DETAILED DESCRIPTION

This disclosure relates to interlocking assemblies for use within cell stacks of a traction battery pack. An exemplary interlocking assembly may include a crossmember frame, a structural thermal barrier, an adhesive, and a rod. The adhesive may be disposed between the crossmember frame and the structural thermal barrier. The rod may then be inserted through the crossmember frame and the structural thermal barrier for retaining the structural thermal barrier to the crossmember frame while the adhesive cures. These and other features are discussed in greater detail in the following paragraphs of this detailed description.

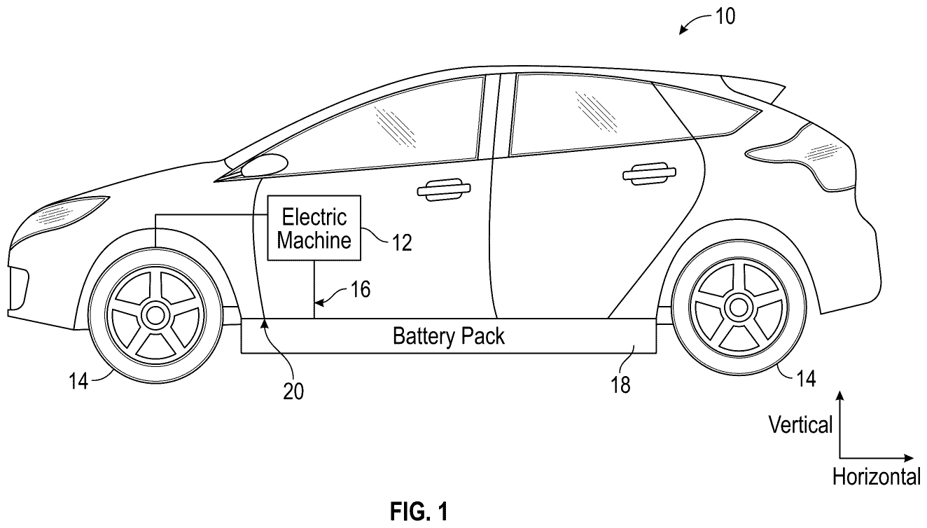

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

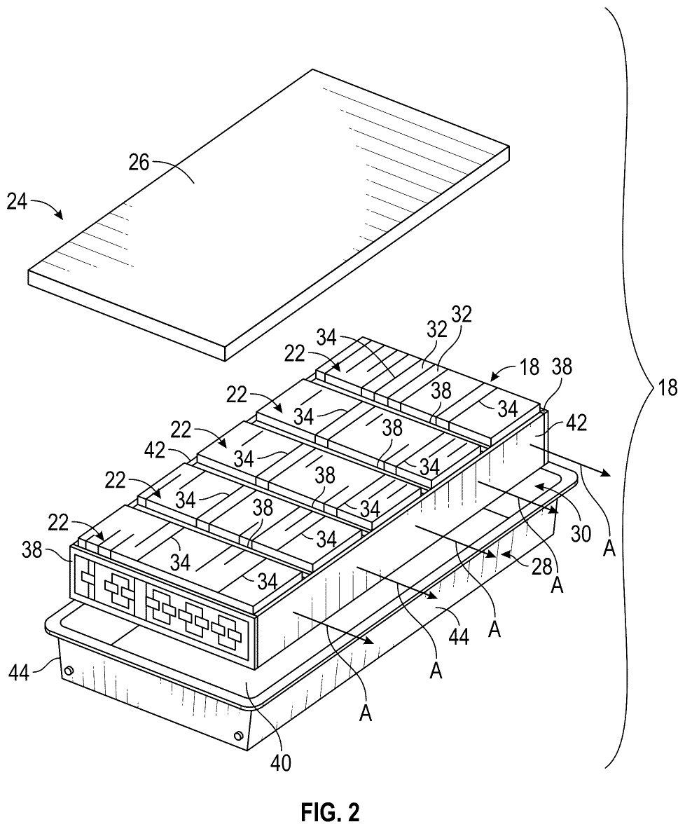

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, for providing the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

The battery cells 32 and the thermal barrier assemblies 34 of each cell stack 22 may be arranged to extend laterally between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed in a direction along each cell stack axis A. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and the cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

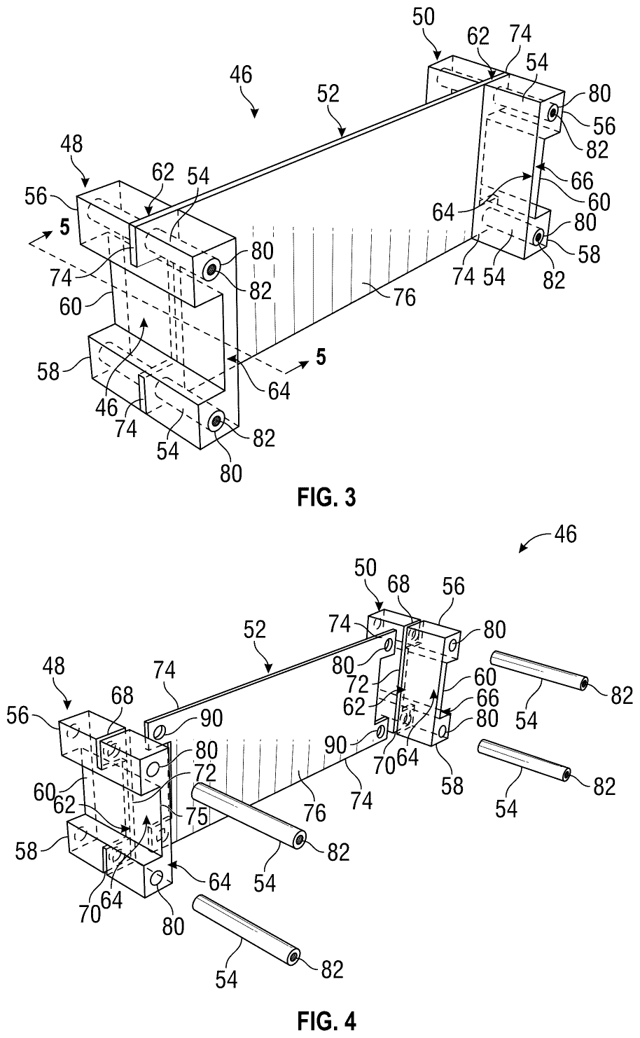

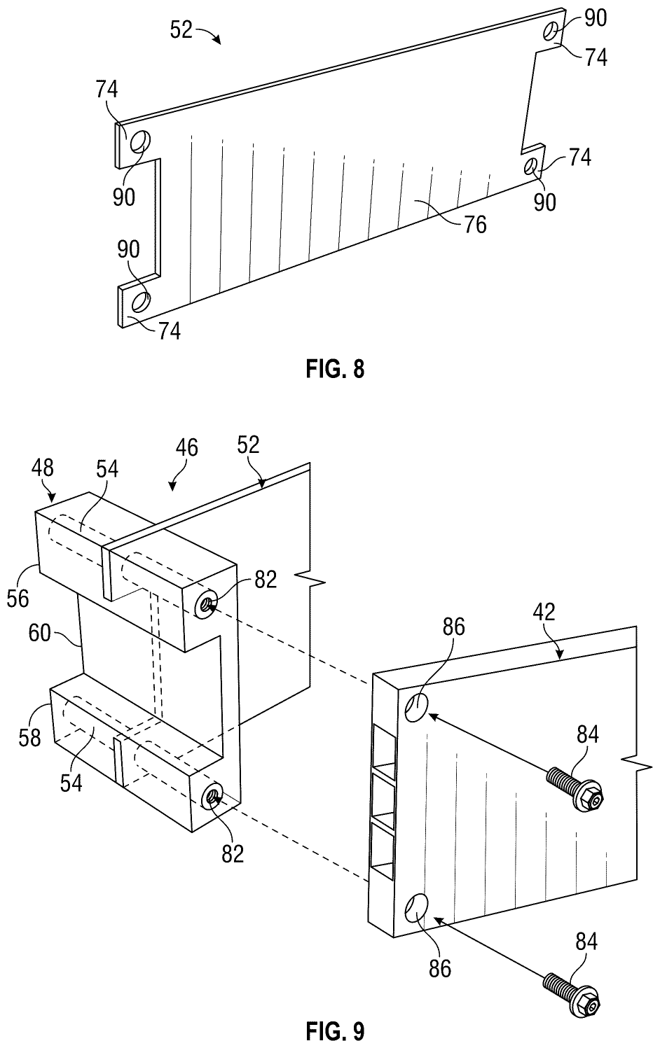

FIGS. 3-8 (with continued reference to FIG. 2) illustrate details associated with an interlocking assembly 46 that can be provided within each cell stack 22 of the traction battery pack 18. As further discussed below, the interlocking assembly 46 may be established by subcomponents of the cross-member assemblies 38 and one or more of the thermal barrier assemblies 34 of each cell stack 22 of the traction battery pack 18.

In an exemplary embodiment, the interlocking assembly 46 includes a first crossmember frame 48, a second crossmember frame 50, a structural thermal barrier 52, and a plurality of rods 54. The first crossmember frame 48 may be a subcomponent of one of the cross-member assemblies 38 of the cell stack 22, the second crossmember frame 50 may be a subcomponent of another one of the cross-member assemblies 38 of the cell stack 22, and the structural thermal barrier 52 may be a subcomponent of one of the thermal barrier assemblies 34 of the cell stack 22. Although a single structural thermal barrier 52 is shown as being part of the interlocking assembly 46, a person of ordinary skill in the art having the benefit of this disclosure would understand that the interlocking assembly 46 could include additional structural thermal barriers 52 connected at different locations of the first crossmember frame 48 and the second crossmember frame 50.

Moreover, it should be appreciated that the size and shape of the first crossmember frame 48 and the second crossmember frame 50 are not intended to limit this disclosure. The first crossmember frame 48 and the second crossmember frame 50 could each be lengthened to accept multiple structural thermal barriers 52 depending on the desired number of battery cells 32 to be included within the cell stack 22.

The first crossmember frame 48 and the second crossmember frame 50 may each include an upper section 56, a lower section 58, and a mid-section 60 that connects between the upper section 56 and the lower section 58. Together, the upper section 56, the lower section 58, and the mid-section 60 provide a unitary body of each of the first and second crossmember frames 48, 50. In an embodiment, the unitary body of each of the first and second crossmember frames 48, 50 is an injection molded structure made of any suitable thermoplastic material. However, other configurations are also contemplated within the scope of this disclosure.

The first crossmember frame 48 and the second crossmember frame 50 may additionally each include an inner facing surface 64 and an outer facing surface 66. The inner facing surfaces 64 face in a direction toward the battery cells 32 of the cell stack, and the outer facing surfaces 66 face in a direction opposite from the battery cells 32 of the cell stack 22, such as toward a neighboring cell stack 22, for example.

The inner facing surface 64 of each of the first crossmember frame 48 and the second crossmember frame 50 may include a channel 62. Each channel 62 may extend vertically across the inner facing surface 64 and may extend into a material thickness of the frame. The channel 62 may extend from the inner facing surface 64 in a direction toward the outer facing surface 66.

The structural thermal barrier 52 may be accommodated within each of the channels 62 in order to arrange the structural thermal barrier 52 to extend laterally between the first crossmember frame 48 and the second crossmember frame 50. In an assembled state of the interlocking assembly 46, the structural thermal barrier 52 can separates adjacent compartments of battery cells 32 of the cell stack 22. The battery cells 32 are intentionally omitted in FIGS. 3-8 for simplicity and clarity.

Each channel 62 may include a first channel portion 68, a second channel portion 70, and a third channel portion 72. The first channel portions 68 may be formed in the upper sections 56 of the first crossmember frame 48 and the second crossmember frame 50, the second channel portions 70 may be formed in the lower sections 58 of the first crossmember frame 48 and the second crossmember frame 50, and the third channel portions 72 may be formed in the mid-sections 60 of the first crossmember frame 48 and the second crossmember frame 50.

The first channel portion 68 and the second channel portion 70 of each channel 62 may extend to a greater depth within the first crossmember frame 48/second crossmember frame 50 compared to the third channel portion 72. In an embodiment, the first channel portion 68 and the second channel portion 70 both pierce through the outer facing surface 66 but the third channel portion 72 does not pierce through the outer facing surface 66.

The first channel portion 68 and the second channel portion 70 are each sized to receive a mounting tab 74 of the structural thermal barrier 52. In an embodiment, one mounting tab 74 is provided at each corner of the structural thermal barrier 52, with each mounting tab 74 projecting laterally outboard from a main body portion 76 of the structural thermal barrier 52. However, other configurations are contemplated within the scope of this disclosure.

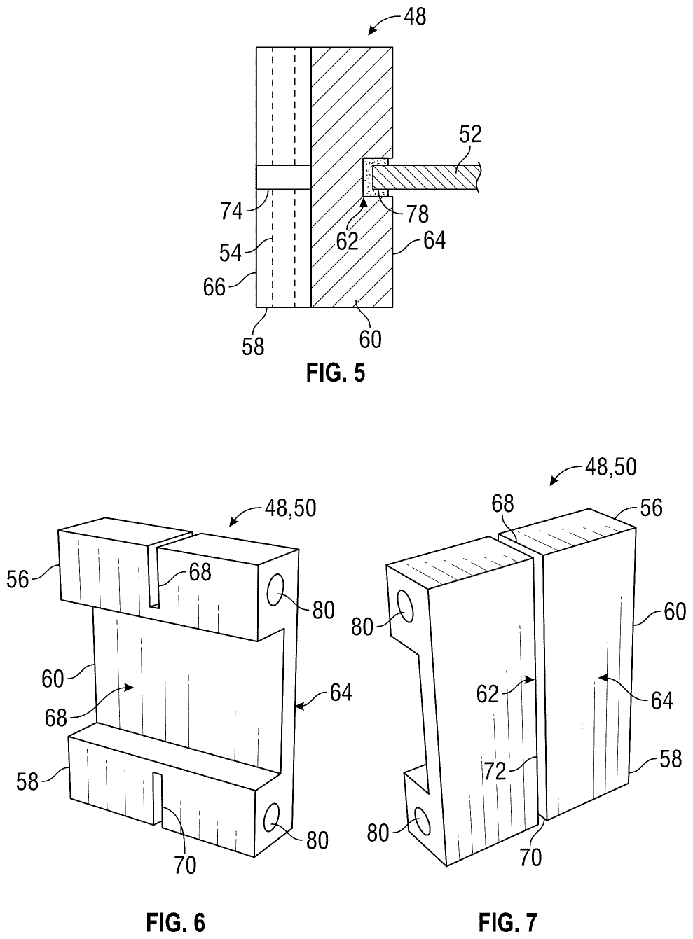

An adhesive 78 (best shown in FIG. 5) may be disposed within each channel 62 prior to insertion of the structural thermal barrier 52 into the channel 62. The adhesive 78 may be applied within each of the first channel portion 68, the second channel portion 70, and the third channel portion 72 of the channel 62. Once cured, the adhesive 78 secures the structural thermal barrier 52 within the channel 62 and thereby seals a gas path between adjacent compartments of battery cells 32 of the cell stack 22. The adhesive 78 may be an epoxy based adhesive or a urethane based adhesive, for example.

A through bore 80 may be formed through the upper section 56, the lower section 58, or both of each of the first and second crossmember frames 48, 50. Each through bore 80 may be sized and shaped to receive one of the rods 54 of the interlocking assembly 46. In an embodiment, the interlocking assembly 46 includes four rods 54, with two rods 54 being secured within the through bores 80 of each of the first crossmember frame 48 and the second crossmember frame 50. However, the interlocking assembly 46 could include a greater or fewer number of rods 54 within the scope of this disclosure. The rods 54 may be metallic components of the interlocking assembly 46, for example.

Each mounting tab 74 of the structural thermal barrier 52 may include an opening 90. The rod 54 may be received through the opening 90 of the mounting tab 74 as the rod 54 is being positioned within one of the through bores 80. The rods 54 may therefore retain the structural thermal barrier 52 in place relative to the first and second crossmember frames 48, 50 while the adhesive 78 cures, thereby reducing the amount of time required for assembling the cell stack 22 during manufacturing.

Referring now primarily to FIGS. 3, 4, and 9, opposing ends of each rod 54 of the interlocking assembly 46 may include a threaded opening 82. The threaded openings 82 may be sized to receive a threaded fastener 84 (e.g., a bolt, screw, etc.) for establishing a structural connection between the cell stack 22 and the structural plate members 42 of the traction battery pack 18. For example, the threaded fasteners 84 may each be inserted through an opening 86 formed through one of the structural plate members 42 and then be screwed into the threaded opening 82 of one of the rods 54 for connecting the structural plate member 42 directly to the interlocking assembly 46. Securing the cell stack 22 to the structural plate members 42 in this manner structurally integrates the traction battery pack 18.

The exemplary traction battery packs of this disclosure include cell stack interlocking assemblies that are capable of holding structural thermal barriers in place with rods while an adhesive applied between crossmember frames and the structural thermal barriers cures. The proposed solutions allow cell stacks to be built up and held in place without a fixture while allowing for additional manufacturing processes to be performed during the adhesive curing time, thereby increasing the speed at which the cell stacks may be assembled.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first crossmember frame including a first channel;
a structural thermal barrier positioned within the first channel;
a first adhesive disposed between the first crossmember frame and the structural thermal barrier; and
a first rod inserted through the first crossmember frame and the structural thermal barrier.

2. The traction battery pack as recited in claim 1, wherein the first rod is configured to retain the structural thermal barrier to the first crossmember frame while the first adhesive cures.

3. The traction battery pack as recited in claim 1, wherein the first crossmember frame is a subcomponent of a cross-member assembly of a cell stack of the traction battery pack, and the structural thermal barrier is a subcomponent of a thermal barrier assembly of the cell stack.

4. The traction battery pack as recited in claim 1, comprising:
a second crossmember frame including a second channel;
the structural thermal barrier positioned within the second channel;
a second adhesive disposed between the second crossmember frame and the structural thermal barrier; and
a second rod inserted through the second crossmember frame and the structural thermal barrier.

5. The traction battery pack as recited in claim 1, wherein the first crossmember frame includes an upper section, a lower section, and a mid-section that connects between the upper section and the lower section.

6. The traction battery pack as recited in claim 5, wherein the first channel extends vertically across an inner facing surface of the first crossmember frame.

7. The traction battery pack as recited in claim 6, wherein a first channel portion of the first channel is formed in the upper section, a second channel portion of the first channel is formed in the lower section, and a third channel portion of the first channel is formed in the mid-section.

8. The traction battery pack as recited in claim 7, wherein the first channel portion and the second channel portion each extend to a first depth of a material thickness of the first crossmember frame, and the third channel portion extends to a second depth of the material thickness, wherein the first depth is greater than the second depth.

9. The traction battery pack as recited in claim 1, wherein the first rod is accommodated within a through bore of the first crossmember frame.

10. The traction battery pack as recited in claim 9, wherein the first rod is received through an opening of a mounting tab of the structural thermal barrier.

11. The traction battery pack as recited in claim 1, the first rod includes a threaded opening sized to receive a threaded fastener.

12. The traction battery pack as recited in claim 11, wherein the threaded fastener is received through an opening of a structural plate member that is arranged between a cell stack of the traction battery pack and a side wall of an enclosure assembly of the traction battery pack.

13. A traction battery pack, comprising:
a cell stack including an interlocking assembly that comprises a first crossmember frame, a structural thermal barrier, and a first rod that secures the structural thermal barrier to the first crossmember frame;
a structural plate member positioned to span an end of the cell stack; and
a first threaded fastener received through a first opening of the structural plate member and configured to engage a first threaded opening of the first rod for securing the structural plate member to the cell stack.

14. The traction battery pack as recited in claim 13, wherein the interlocking assembly includes a second crossmember frame and a second rod that secures the structural thermal barrier to the second crossmember frame.

15. The traction battery pack as recited in claim 14, comprising a second threaded fastener received through a second opening of the structural plate member and being configured to engage a second threaded opening of the second rod for further securing the structural plate member to the cell stack.

16. The traction battery pack as recited in claim 13, wherein the structural thermal barrier is positioned within a first channel of the first crossmember frame.

17. The traction battery pack as recited in claim 16, comprising an adhesive disposed between the structural thermal barrier and the first crossmember frame.

18. The traction battery pack as recited in claim 16, wherein the first channel extends vertically across an inner facing surface of the first crossmember frame.

19. The traction battery pack as recited in claim 13, wherein the first rod is accommodated within a through bore of the first crossmember frame.

20. The traction battery pack as recited in claim 13, wherein the first crossmember frame is a subcomponent of a cross-member assembly of the cell stack, and the structural thermal barrier is a subcomponent of a thermal barrier assembly of the cell stack.
